(19) United States
(12) Patent Application Publication
(10) Pub. No.: US 2006/0198410 A1
(43) Pub. Date: Sep. 7, 2006

(54) Laser exposure apparatus for exposing a screen held in a frame

(76) Inventor: Josef Lindthaler, Bad Oeynhausen (DE)

Correspondence Address: WELSH & KATZ, LTD, 120 S RIVERSIDE PLAZA, 22ND FLOOR, CHICAGO, IL, 60606, US

(21) Appl. No.: 11/358,413

(22) Filed: Feb. 21, 2006

(30) Foreign Application Priority Data
Feb. 18, 2005 (DE) 102005007439.1-51

(51) Int. Cl. H01S 3/14

(52) U.S. Cl. 372/39

(57) ABSTRACT

The subject matter of the invention is a laser exposure apparatus for exposing a screen (24) held in a frame (28), more specifically for Computer-to-Screen exposure. A low-cost method and a low-cost laser exposure apparatus of the type mentioned herein above by means of which the screen is readily held in an accurately defined position during exposing are achieved by having the screen holding device (10) including a screen support (22) with a defined supporting surface, with the screen support (22) being disposed in such a manner that the screen (24) is adapted to be placed onto said screen support (22) whilst the frame (28) is freely suspended beside said screen support (22), being held by said screen (24), and that at least one positioning pin (16, 18) mounted to said screen holding device (10) engaging into a positioning opening (30, 32) provided on said frame (28) if said screen (24) rests on said screen support (22).

### FIELD OF INVENTION

The present invention relates to a laser exposure apparatus in accordance with the preamble of claim 1. In screen printing, the light-sensitive screens are exposed by laser exposing with a certain image and then coated with an emulsion that only adheres to the areas intended for this purpose. On the other areas of the screen to which the emulsion did not adhere, the desired color may then pass through the screen and reach the element that is to be printed. During laser exposure, a laser is focused on the screen through a corresponding optics in order to reproduce the image on the screen. In order for the image on the screen to be sharp, it is important that the screen be effectively placed in the focus of the laser. The screen only needs be out of focus by one tenth of a millimetre to produce a blurred image.

### DESCRIPTION OF THE PRIOR ART

Using inkjet printers or wax coating methods, EP 0 811 484 Al in particular teaches to place the screen onto a support, with the frame holding the screen being suspended beside the support. As a result, the screen is accurately positioned in the Z direction. Positioning in the XY direction occurs through an angular limit stop against which the screen is pushed, together with the frame. Such positioning is not suitable for an automated screen printing machine since the screen may slip out of place as the table is moved beneath the laser exposure device.

From WO 01/70503 A1 it is known to place the screen for screen printing onto a highly accurate honeycomb supporting plate and to press the frame onto the supporting plate by means of a plurality of pneumatic microcylinders in such a manner that the screen rests over a large area on the supporting plate. Two projections in each of which there is provided a circular positioning opening into each of which a positioning pin may engage are integrally formed with said frame. The positioning pins are held on slides for bringing the pin for positioning each frame in the desired position. The screen is placed manually since it is the only way for the slide holding the positioning pins to be supplied and for the microcylinders to act onto the frame.

### BRIEF SUMMARY OF THE INVENTION

In view thereof, the problem underlying the present invention was to provide a laser exposure apparatus of the type mentioned herein above by means of which the screen and the frame may be supplied automatedly to the laser exposure apparatus while being held in a precisely defined position.

As a technical solution to this problem, the present invention proposes a laser exposure apparatus having the features of claim 1. Advantageous developed implementations of this laser exposure apparatus will become apparent in the subordinate claims.

A laser exposure apparatus according to the teaching of this invention has the advantage that the self-weight of the frame maintains the screen subjected to load during laser exposure, with the screen being thus in a defined position at the crucial moment in time. This position of the screen can be determined with an accuracy of one tenth of a millimeter so that the screen is always disposed in the focus of the laser, which results in accurate exposure and, as a result thereof, sharp images are obtained.

Another advantage is that it is now no longer the frame that rests on the supporting plate but the screen itself so that the distance between the laser exposure apparatus and the screen is always accurately defined. The frames, of different thickness, no longer influence the actual position of the screen since they are now freely suspended beside the screen support.

It has been found advantageous to stretch the screen on the frame transversely with respect to the screen surface. The screen is thereby held in the frame as usual and is stretched transversely with respect to the screen surface by applying a force. This force pushes the screen out of the actual plane of the screen according to the existing loose or clearance until the screen is sufficiently tightened. It is understood that this position can be detected in order to bring the focus of the laser in the plane of the stretched screen, using suitable means.

It is advantageous to apply the force to the screen at a plurality of locations in order to stretch the screen at these locations to form a surface, this surface being preferably configured to be parallel to the plane of the frame. It is thus made certain that the screen is stretched to a surface at least in the region of the useful exposure and that it can be brought into a defined position.

The utilization of positioning pins and positioning openings has the advantage that the screen will always adopt an accurately defined position in the machine and relative to the laser exposure apparatus so that the image generated by the exposure can be found at an accurately defined location. This facilitates mechanical positioning of the already exposed screen during the subsequent screen printing process because it allows calibration of the screen to be eliminated.

Another advantage is that the positioning pins fix the frame on the screen holding device so as to prevent it from coming out of place, the screen being thus reliably prevented from slipping out of place when the screen holding device is moved beneath, or from beneath, the laser exposure apparatus.

Another advantage of the laser exposure apparatus is that the screen is brought into the final position, together with the frame, by placing it onto the screen holding device. The frame is thereby accurately placed and retained by the positioning pins while the screen is stretched by the self-weight of the frame. As a result, the screen can be mechanically placed onto the screen holding device, thus reducing the cost.

It has thereby been found advantageous to configure the positioning openings to correspond to, and register with the positioning pins with zero clearance with respect thereto, in order to achieve exact positioning of the screen.

In another preferred embodiment, it has been found advantageous to configure one positioning opening as a long hole and to keep the other positioning opening circular. This not only permits to ensure, via the circular positioning opening, the exact positioning of the screen and to reliably prevent, via the second positioning pin, the screen from slipping or rotating out of place but also to prevent, via the long hole, the frame from jamming when the screen is being placed into, or removed from, the screen holding device.

Another advantage is that such a screen stretching device configured to be a screen support can be manufactured at very low cost since it has a simple construction and no movable parts.

In a preferred embodiment, it has been found advantageous to configure the screen support as a perimeter ledge projecting upward, a planar supporting surface being formed on said ledge. The advantage thereof is that such a ledge provides a large supporting surface for the screen so that the surface pressure will more specifically remain low, with no damage to the screen. In an alternative embodiment, the screen support is formed from at least four stamps extending upward, each stamp comprising a planar supporting surface with the supporting surface and the stamp being aligned. Such a screen support formed from stamps can be manufactured at low cost and also stretches the screen in the manner described herein above.

It has thereby been found advantageous to dispose the screen support on the border of the screen although not in the region of the frame so that the screen will be stretched and the area to be exposed still relatively large.

Further advantages of the laser exposure apparatus of the invention will become apparent in the appended drawings and in the following description of embodiments thereof. Likewise, the invention lies in each and every novel feature or combination of features mentioned above or described herein after. The embodiments discussed herein are merely exemplary in nature and are not intended to limit the scope of the invention in any manner. In the drawing:

### BRIEF DESCRIPTION OF THE DRAWING

FIG. 1 shows a perspective partial view of a laser exposure apparatus of the invention with a screen held in a frame;

FIG. 2 shows a side view of the laser exposure apparatus of FIG. 1 at a first moment in time;

FIG. 3 shows a side view of the laser exposure apparatus of FIG. 1 at a second moment in time;

FIG. 4 shows a top view of a screen holding device of the laser exposure apparatus of FIG. 1, with a screen placed thereon;

FIG. 5 shows a side view of the laser exposure apparatus of FIG. 1 at a third moment in time;

FIG. 6 shows an enlarged detail of the laser exposure apparatus of FIG. 1 taken along a line VI in FIG. 5;

FIG. 7 shows a top view of a second embodiment of a screen in accordance with the invention.

### DETAILED DESCRIPTION OF THE INVENTION

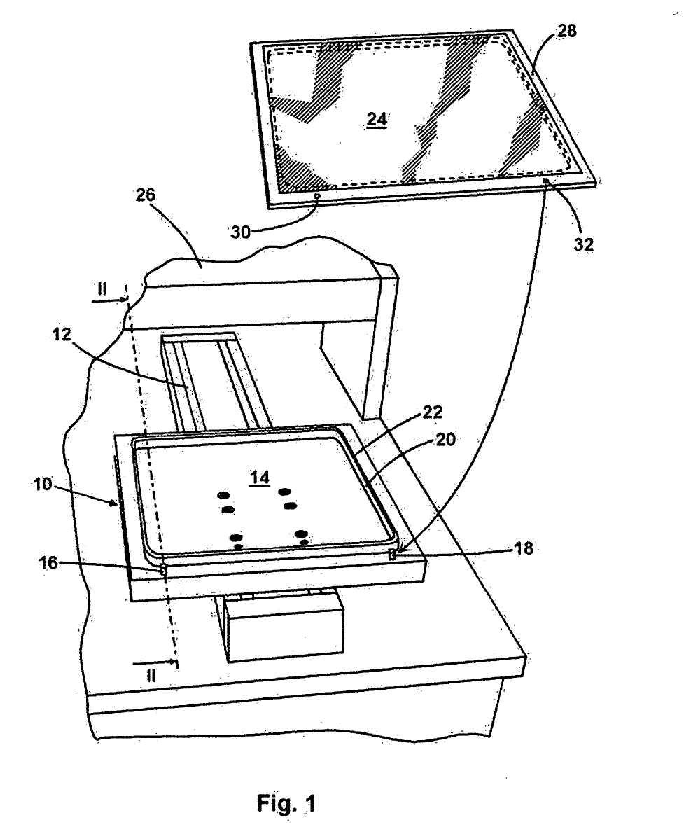

FIG. 1 is a perspective view showing a part of a laser exposure apparatus according to the present invention. This laser exposure apparatus includes a linearly displaceable screen holding device 10 that is held for linear displacement in a corresponding guide track 12. The screen holding device 10 includes a substantially horizontally oriented table 14 on the border of which there are mounted two vertically protruding positioning pins 16, 18. Further, a perimeter and upwardly protruding ledge 20 on the upper side of which there is formed a screen support 22 is provided on said table 14. The upper side of the ledge 20 is thereby configured to be a planar supporting surface on which a screen 24 may be placed.

A box 26 of the laser exposure apparatus, which has merely been outlined herein, accommodates the laser itself and the screen holding device 10 traveling along the guide track 12 may be moved beneath the laser in such a manner that the screen 24 resting on the screen support 22 is positioned exactly in the focus of the laser.

The placing and stretching of the screen 24 will be described in detail herein after:

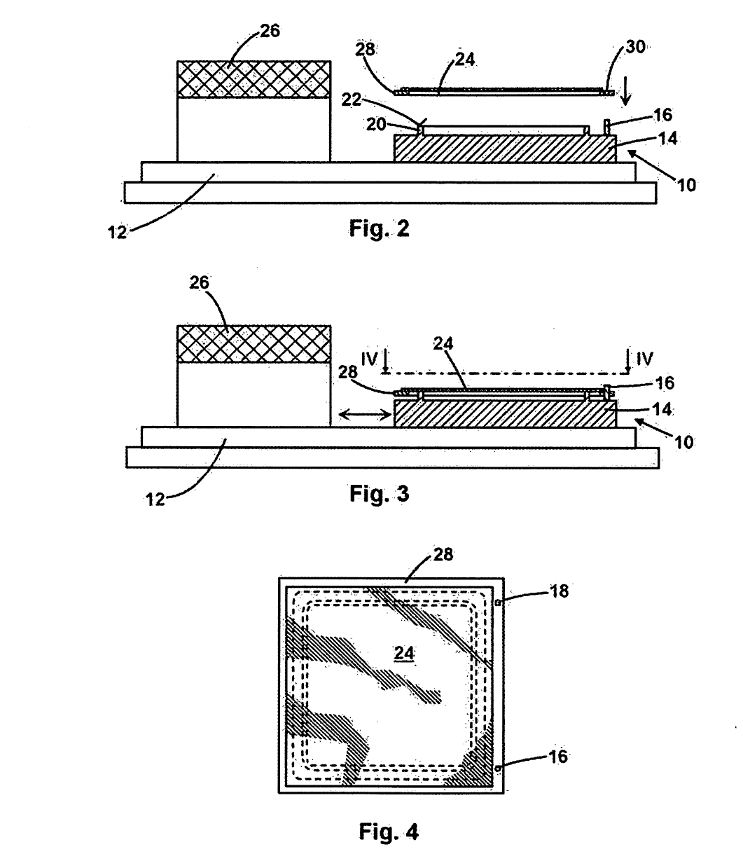

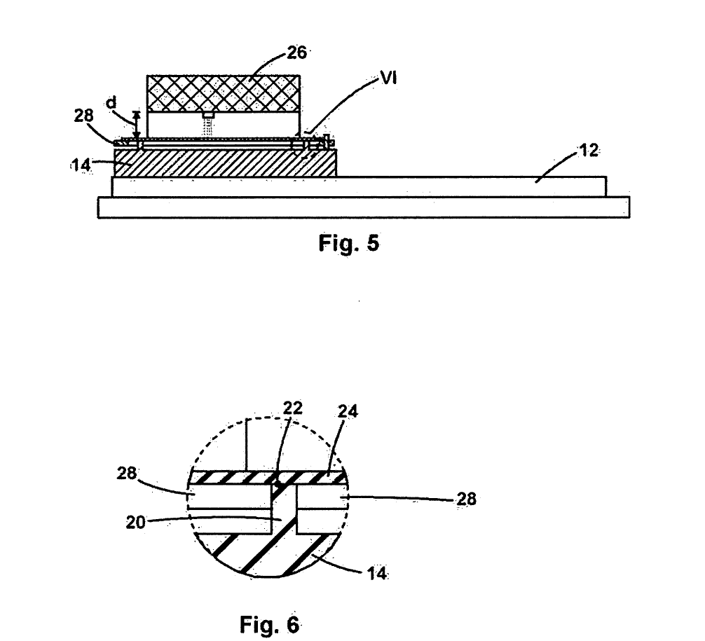

The screen 24 needed for screen printing is held in a frame 28, being thereby pre-biased by a certain amount. At a defined location in the frame 28 there are provided two positioning openings 30, 32 for the positioning pins 16, 18 to engage. To expose a thus prepared screen 24 with a laser, the screen 24 is placed, together with the frame 28, onto the screen support 22, which has been pulled forward along the guide track 12. As can be seen from the FIGS. 2 through 6, the screen 24 is placed onto the perimeter ledge 20 in such a manner that the screen 24 is brought to fit directly on the screen support 22 whilst the frame 28, which is held by the screen 24, is freely suspended. At the same time, the frame 28 is positioned in such a manner that the positioning pins 16, 18 extend through the positioning openings 30, 32 so that the frame 28 is positioned at a defined location on the screen holding device 10.

As shown in greater detail in FIG. 3, the frame 28 thereby is freely suspended with only the screen 24 resting on the screen support 22. The screen 24 is retained on the screen support 22 and even slightly stretched by the self-weight of the frame 28, which is usually made from metal. Since the exact position of the screen support 22 is previously known, the exact position of the screen 24, which has been placed directly onto the screen support 22, is also known so that the exact position of the screen 24 is known when the screen holding device 10 is pushed along the guide track 12 beneath the box 26, this allowing for the laser to be focused with the accuracy needed to project a sharp image onto the screen 24.

After the screen has been laser exposed accordingly, the screen holding device 10 needs merely be pulled forward along the guide track 12 to remove the screen 24 from the screen support 22 for further processing.

In another embodiment that has not been illustrated herein, the screen support may be formed, rather than from the perimeter ledge, from a number of stamps, preferably from four stamps, which also comprise a planar supporting surface at their end face.

In still another embodiment that has not been illustrated herein, the screen may be arranged vertically and moved into the focus of the laser exposure apparatus by means of a slide, for example. In this embodiment, the screen can be pre-biased by accordingly displaceable stamps or by an accordingly displaceable perimeter ledge. Thereby, the stamps or the ledge are moved horizontally and displaced toward the screen transversely with respect to the screen surface until the screen is stretched accordingly. Then, the exact position of the screen can be determined, based on the position of the supporting surfaces of the stamps or of the ledge so that the laser may be focused onto this position.

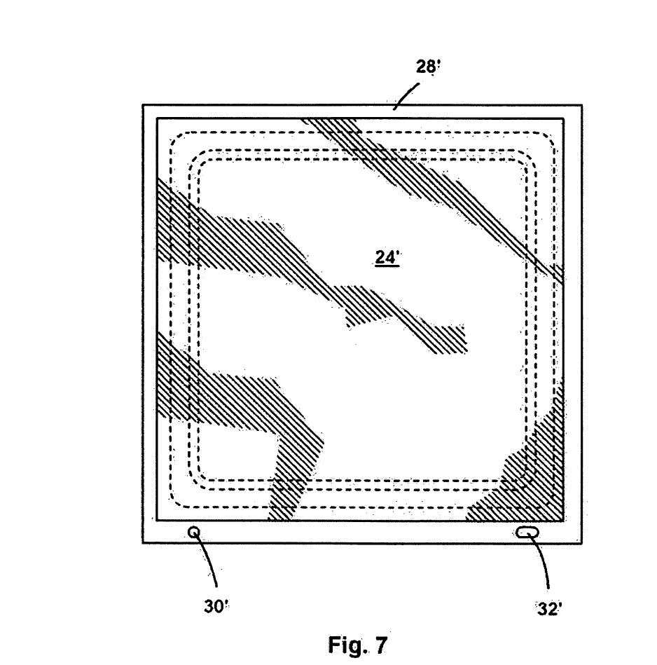

In an alternative embodiment illustrated in FIG. 7, a first positioning opening 30, in the screen 24′ is configured to be circular whereas the second positioning opening 32′ is configured to be a long hole. As a result, the frame 28′ is prevented from jamming when the screen 24′ is placed onto, or removed from, the screen holding device 10.

### List of Numerals

10 screen holding device
12 guide track
14 table
16 positioning pins
18 positioning pins
20 ledge
22 screen support
24, 24′ screen
26 box
28, 28′ frame
30, 30′ positioning openings
32, 32′ positioning openings

We claim:

1. A laser exposure apparatus for exposing a screen (24) held in a frame (28), said laser exposure apparatus having an exposing unit and a screen holding device (10) for defined positioning of the screen (24) to be exposed, whereas said screen holding device (10) includes a screen support (22) having a defined supporting surface, said screen support (22) being arranged in such a manner that said screen (24) is adapted to be placed onto said screen support (22) whilst said frame (28) is freely suspended beside said screen support (22), being held by said screen (24), and whereas at least one positioning pin (16, 18), mounted to said screen holding device (10) engages into a positioning opening (30, 32) provided on said frame (28) if said screen (24) rests on said screen support (22).

2. The laser exposure apparatus as set forth in claim 1, whereas exactly two positioning pins (16, 18) and two positioning openings (30, 32) are provided.

3. The laser exposure apparatus as set forth in claim 1, whereas the positioning pins (16, 18) have a circular cross section.

4. The laser exposure as set forth in claim 1, whereas the positioning pins (16, 18) are adapted to be inserted into the positioning openings (30, 32) so as to correspond to, and register with zero clearance with said positioning pins.

5. The laser exposure apparatus as set forth in claim 2, whereas the two positioning pins have a circular cross section, with one positioning opening (30′) configured to have a circular cross section for registering with and receiving with zero clearance a positioning pin, whilst the other positioning opening (32′) is configured to be a long hole for registering with and receiving, in one direction with zero clearance and in the other direction with clearance, said positioning pin.

6. The laser exposure apparatus as set forth in claim 1, whereas the screen support (22) is configured as a perimeter ledge (20) projecting upward, and whereas a planar supporting surface is being formed on said ledge (20).

7. The laser exposure apparatus as set forth in claim 1, whereas the screen support includes at least four upwardly projecting stamps, with each stamp comprising a planar supporting surface and said supporting surface of the stamps being aligned.

8. The laser exposure apparatus as set forth in claim 1, whereas the screen support (22) is brought to fit against the border of the screen (24).
